(19) United States
(12) Patent Application Publication
(10) Pub. No.: US 2023/0399069 A1
(43) Pub. Date: Dec. 14, 2023

(54) COOLER AND METHOD FOR PRODUCING A COOLER

(71) Applicant: KTM AG, Mattighofen (AT)

(72) Inventor: Martin MAGELE, Uttendorf (AT)

(21) Appl. No.: 18/206,839

(22) Filed: Jun. 7, 2023

(30) Foreign Application Priority Data
Jun. 8, 2022 (AT) A 50399/2022

(51) Int. Cl. B62J 41/00

(52) U.S. Cl. CPC B62J 41/00

(57) ABSTRACT

A cooler is provided for cooling liquid, in particular of an engine of a motorcycle. The cooler has a plate-like cooler core for exchanging heat between a coolant and ambient air, and the cooler core has a planar middle region. The cooler core has a bend at each of at least two preferably opposite sides of the planar middle region.

### BACKGROUND OF THE INVENTION

A cooler for cooling liquid, in particular of an engine of a motorcycle, has a plate-like cooler core for exchanging heat between a coolant and ambient air. The invention also relates to a motorcycle having a cooler of said type. The invention furthermore relates to a method for producing a cooler.

A “cooler core” refers generally to that part of the cooler in which the exchange of heat between coolant and ambient air predominantly takes place. The cooler core can have at least one cooling pipe, wherein the at least one cooling pipe leads with multiple, in particular meandering, curves through the cooler core. Furthermore, the cooler core can have cooling fins, wherein the cooling fins are thermally connected to the at least one cooling pipe. The at least one cooling pipe and the cooling fins have a large surface area so that an efficient exchange of heat between the coolant situated in the at least one cooler pipe and the ambient air can take place.

“Plate-like” means that a depth dimension is significantly smaller than the two other dimensions. In this application, “plate-like” also encompasses a bent plate, even if said plate is not bent using the “bending” form of deformation.

Coolers of the type mentioned at the start are already known as prior art. They are generally used to cool the engine, the engine oil or other components of a motorcycle by means of a liquid coolant. Typically, cooling lines that are connected to coolant inlets and coolant outlets of the cooler lead from the cooler to the part of the motorcycle which is to be cooled. The liquid coolant, optionally driven by a pump, circulates in these lines. The liquid coolant can for example be a mixture of water and glycol. However, other coolants, such as oil, can also be provided, wherein the cooler can be formed in particular as a tubular oil cooler.

As a result, heat can be dissipated from the component that is to be cooled and, in particular as flow passes through the cooler core, released to the ambient air. To ensure an efficient exchange of heat, the cooler core has coiled pipes with a large surface area, through which the coolant flows.

When the motorcycle is traveling at low speeds or is at a standstill, only a slow release of heat to the ambient air is possible. A fan, which is activated when required, is therefore often provided on the cooler core. Typically, the fan is arranged between the cooler core and the engine and draws air through the cooler core.

Cooler cores with a bent shape are likewise known as prior art. In this way, the area of the cooler core can be enlarged whilst maintaining the same lateral extent.

The arrangement of a fan on bent cooler cores is, however, problematic because the fan for the most part does not lie directly against the cooler core, and the size of the fan is limited by the bend. Cooling performance is thus reduced. Furthermore, additional components, such as for example a bracket for fastening the cooler to the motorcycle, can be mounted only after the cooler core has been bent. Because the bending is preferably carried out after the cooler core has been brazed, an additional component cannot be arranged on the cooler core prior to the brazing, as a result of which the component cannot be brazed on concomitantly.

A further disadvantage of a cooler core with a bent shape compared with a planar cooler core is that, when the cooler is in operation, a major part of the surface is oriented obliquely with respect to the direction of travel, as a result of which air cannot flow through the cooler core without being deflected, because the cooling fins are typically oriented substantially perpendicular to the surface of the cooler core. This gives rise to an increased resistance.

A “bend” of the cooler core refers to a curvature of a substantially plate-like cooler core through at least 1°. The curvature can be produced, starting from a planar cooler core, by the “bending” form of deformation. However, other production methods are also conceivable.

The Japanese patent JP 6428346 B2 presents a bent cooler core, wherein the fan is arranged on an eccentric planar side surface. However, the rest of a motorcycle must also be adapted to such an eccentric arrangement of the fan, which involves additional outlay on design. Brackets for fastening the fan to the motorcycle can also be attached in the bend of the cooler core only retroactively, or must be attached to the sides of the cooler core. Both cases thus involve additional outlay on production.

### SUMMARY OF THE INVENTION

The object of the present invention is to create a cooler, a motorcycle having a cooler, and a method for producing a cooler, which at least partially avoid the disadvantages of the prior art. In particular, it is intended to create a cooler which makes good cooling performance of the coolant possible, is of space-saving design and makes a simplified and less expensive fastening of additional components possible.

According to the invention, the cooler core has a planar middle region, wherein the cooler core has a bend at each of at least two preferably opposite sides of the planar middle region.

The advantages of a bent cooler core are thus combined with the advantages of a planar cooler core.

By virtue of the fact that the cooler core has a planar middle region, the present invention has the advantages of a planar cooler core in the middle region.

An improved flow of air is possible through the planar middle region, in particular because the cooling fins are oriented substantially perpendicular to the surface of the cooler core. In the middle region, the air can flow substantially straight through the cooler core.

An advantage of a planar cooler core is the simplified mounting of a fan centrally and directly on the cooler core, wherein even relatively large fans of standard design can be installed. As a result, the cooling performance is increased, whilst costs are saved. A further advantage of a planar cooler core is that additional components, such as a bracket for fastening the cooler core to the motorcycle, can be brazed together with the cooler core in one step. There is thus no need for the additional components to be retroactively welded or screwed on.

By virtue of the fact that the cooler core has a bend at each of at least two preferably opposite sides of the planar middle region, the invention also has the advantages of a bent cooler core. An advantage of a bent cooler core is the larger area of the cooler core whilst maintaining the same lateral extent. The lateral extent of the motorcycle is thus smaller, or more space is created for other components of the motorcycle, for example for a spoiler.

In a preferred embodiment, the cooler core is bent in the same direction at least at two opposite sides of the planar middle region. In other words, both bends are thus formed concave as seen from a first side and convex as seen from a second side. If the cooler, when installed in the motorcycle, is formed concave as seen from the front side of the motorcycle, more air can be collected when traveling, which increases the cooling performance. It is preferably provided here that the entire cooler core is formed concave as seen from a first side and convex as seen from a second side.

In an embodiment, the cooler core is not bent along one direction. In other words, the bend axes of all bends of the cooler core are parallel to one another and to the aforementioned direction. Here, it is preferably provided that said one direction corresponds to a width direction of the cooler core. The cooler core is thus bent in a longitudinal direction and is not bent in a width direction.

The planar middle region can be formed substantially rectangular.

In addition or alternatively, the planar middle region can be arranged in the center of the area of the cooler core. A fan and/or a bracket for fastening the cooler core to the motorcycle can thus be arranged centrally.

Preferably, the planar middle region occupies an area of more than one quarter, in particular more than one third, of the total area of the cooler core. A relatively large fan can thus be arranged on the planar middle region.

In a further embodiment, the planar middle region occupies an area of from 200 to 400, in particular of approximately 330, square centimeters. Even a relatively large fan, for example with a diameter of approximately 195 mm, can thus be arranged predominantly in the planar region.

By virtue of the fact that the fan lies against the planar middle region of the cooler core, the fan can be easily fastened, in particular directly to the cooler core, by means of suitable fastening means that run through the cooler core.

The cooler core can be formed substantially as a bent rectangular plate, wherein the cooler core has a longitudinal direction and a width direction. The cooler core is longer in the longitudinal direction than in the width direction, and the longitudinal direction is orthogonal to the width direction.

The planar middle region can be shorter in the longitudinal direction than in the width direction of the cooler core. In addition or alternatively, the planar middle region can be between 140 mm and 150 mm, preferably approximately 145 mm, in size in the longitudinal direction of the cooler core. A fan which has a diameter of approximately 195 mm, for example, can thus be arranged predominantly in the planar middle region.

In the longitudinal direction of the cooler core, the planar middle region can occupy more than one quarter, in particular more than one third, of the length of the cooler core.

The planar middle region can extend over the entire width of the cooler core. An adjoining front side of the cooler core is thus also formed straight in this portion. Components, in particular a bracket for fastening the cooler core to the motorcycle, can be attached to such a straight portion, even before the cooler core is bent.

In an embodiment, the two bends that partially delimit the planar middle region have the same bend radius and/or the same bend angle. The cooler core can thus be formed substantially mirror-symmetrical.

Preferably, the bend radius of at least one bend can be between 180 mm and 220 mm, in particular approximately 200 mm, and/or the bend angle of at least one bend can be between 18° and 22°, in particular approximately 20°. External dimensions similar to those of a simple bent cooler core known from the prior art can thus be achieved. The cooler can thus be attached to motorcycles of the same design.

A large bend angle advantageously leads to a smaller extent whilst maintaining the same surface area of the cooler core. However, a large bend angle also leads to a greater deflection of the air in the cooler core, because the surface normals of the surfaces beyond the bends differ to an ever greater degree from the flow direction of the air when the motorcycle is traveling. It is thus necessary to find a compromise for the bend angle, whilst taking account of the aforementioned conditions.

In a particularly preferred embodiment, at least one fan is arranged on the planar middle region, preferably wherein the fan is arranged over the major part of its area, particularly preferably over more than three quarters of its area, within the planar middle region. A large standard fan can thus be arranged on the cooler core without an intermediate space, whereby the cooling performance is increased.

Therefore, the fan can be arranged directly on the cooler core, preferably without an intermediate space. The fan is preferably fastened directly to the cooler core by means of fastening means. There is thus no need for any further fastening device for the cooler, which saves on components and costs.

In a further embodiment, at least one bracket for fastening the cooler core to a motorcycle is arranged on the cooler core or on at least one side strip on at least one front side of the cooler core. The at least one bracket is particularly preferably fastened to the cooler core or to the at least one side strip by brazing. The bracket can thus be fastened, together with the cooler core itself, to the cooler core in one working step by brazing. The bracket therefore does not need to be retroactively welded or screwed on.

The planar middle region can extend as far as at least one front side of the cooler core, wherein the at least one side strip of the at least one front side is formed straight in a portion adjoining the planar middle region, and wherein the at least one bracket is arranged on said straight portion of the at least one side strip. The at least one bracket can thereby be fastened to the at least one side strip before the cooler core is bent. This makes it possible, during the brazing of the cooler core that must take place prior to the bending, for the at least one bracket to be concomitantly brazed onto the at least one side strip. It is therefore no longer necessary for the at least one bracket to be retroactively manually welded on or fastened in some other way.

The cooler core and/or at least one bracket for fastening the cooler core to a motorcycle and/or at least one side strip on a front side of the cooler core is manufactured from aluminum. This makes joint recycling possible without disassembly.

At a side of at least one, preferably both, bend(s) situated opposite the planar middle region, a planar side region of the cooler core can be arranged.

At a side of at least one, preferably both, bend(s) that is situated opposite the planar middle region, a coolant reservoir can be arranged. Particularly preferably, a coolant reservoir is arranged at each of the two ends of the cooler core, beyond the bends. The cooling pipes in the cooler core lead from one coolant reservoir into the other coolant reservoir.

At a side of at least one, preferably both, bend(s) situated opposite the planar middle region, a coolant inlet and/or a coolant outlet can be arranged. Cooling lines that lead to the engine of a motorcycle can be attached to the coolant outlet and/or to the coolant inlet. Coolant can flow through the at least one cooling pipe from the coolant inlet to the coolant outlet. The coolant inlet is preferably arranged on a first coolant reservoir, whilst the coolant outlet is preferably arranged on a second coolant reservoir.

According to the invention, a motorcycle having a described cooler is also provided, wherein the cooler core is arranged between the front wheel and the engine of the motorcycle.

In a preferred embodiment of the motorcycle, the cooler core is bent, at least at two opposite sides of the planar middle region, in the direction of the front wheel. Incoming air flowing from the direction of the front wheel during travel can thus be better captured.

Preferably, the fan is arranged between the cooler core and the engine. Through this central arrangement, the fan is protected and is arranged so as not to be clearly visible.

Coolant lines lead from the cooler to the engine and/or to a heat exchanger for cooling oil, for example engine oil for the engine. The coolant lines are connected to a coolant inlet and a coolant outlet such that coolant can flow through the cooler, in particular through the at least one cooling pipe in the cooler core.

A method according to the invention for producing a cooler has the following method steps:
providing a substantially plate-like, planar, preferably rectangular, cooler core,
bending the cooler core in at least two places such that the cooler core has a bend at each of at least two preferably opposite sides of a planar middle region.

In a preferred embodiment, the following method steps are provided:
arranging at least one fan on the planar middle region, wherein the fan is arranged directly on the cooler core, preferably without an intermediate space,
fastening the at least one fan directly to the cooler core by means of fastening means.

The cooler core is preferably brazed before the cooler core is bent. Here, the individual parts of the cooler core, in particular the at least one cooling pipe and/or the cooling fins, are brazed together. Side strips can also be concomitantly brazed on. The fully brazed cooler core, optionally together with side strips, can then be bent.

Furthermore, before the brazing, a bracket is arranged on the cooler core or on at least one side strip on a front side of the cooler core, and that, during the brazing of the cooler core, the bracket is concomitantly brazed onto the cooler core or onto the side strip. The bracket therefore does not need to be welded on, or attached in some other way, in an additional working step. The bracket can be arranged in a portion of the side strip that adjoins the planar region, or directly on the cooler core, wherein said portion is not bent by the bending and remains as a straight portion.

### BRIEF DESCRIPTION OF THE INVENTION

Further embodiments and details are apparent from the figures, in which:

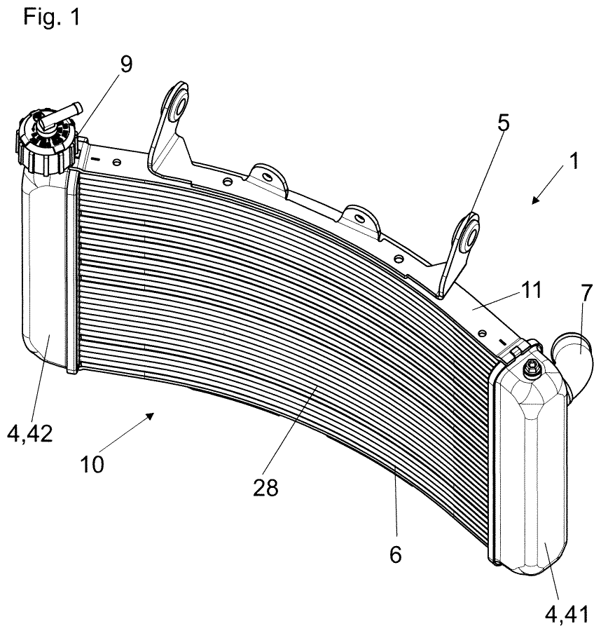

FIG. 1 shows a cooler with bent cooler core (prior art), in a perspective view;

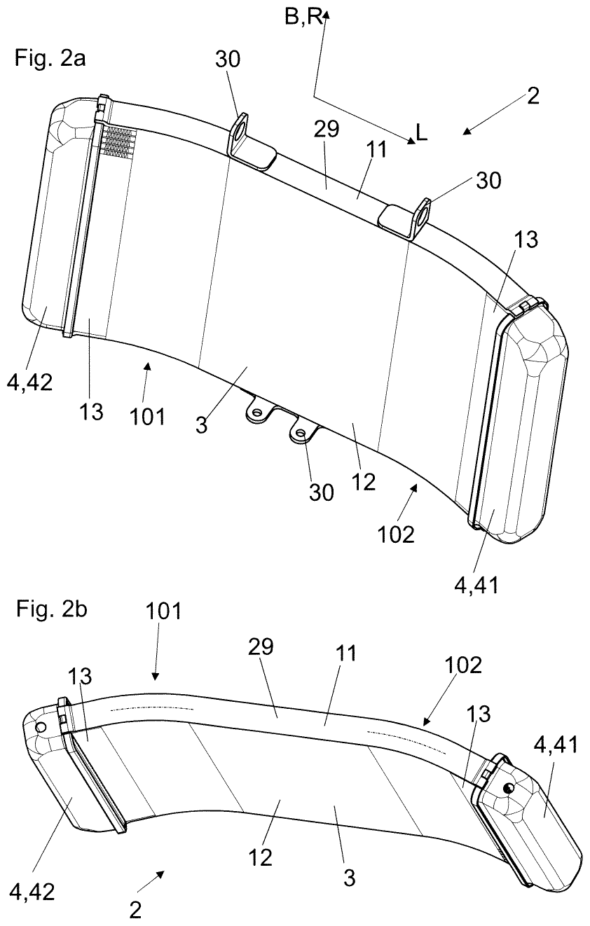

FIG. 2a shows a cooler with a planar region and two bends and a bracket, in a perspective view;

FIG. 2b shows a cooler with a planar region and two bends, without a bracket, in an alternative perspective view;

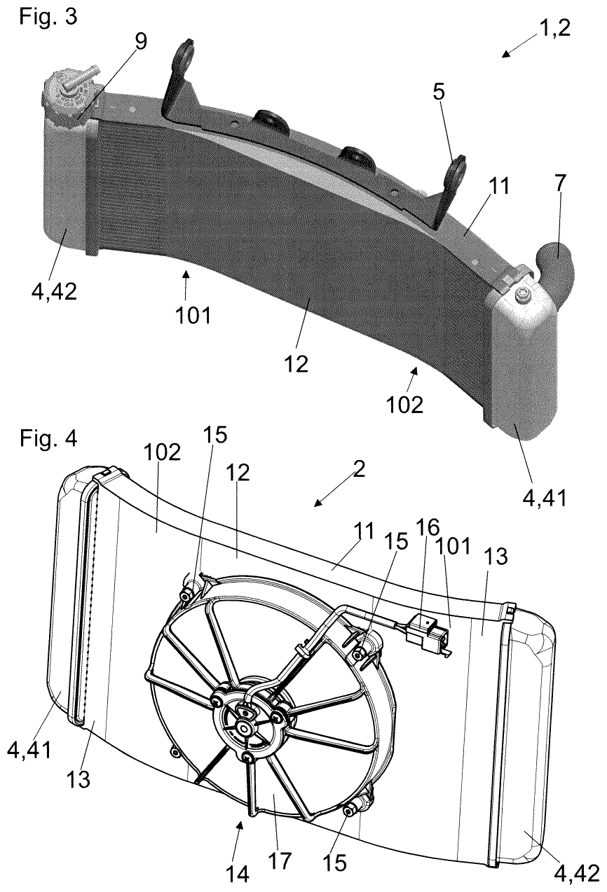

FIG. 3 shows a comparison of the coolers from FIGS. 1 and 2b;

FIG. 4 shows a the cooler from FIG. 2b with a fan;

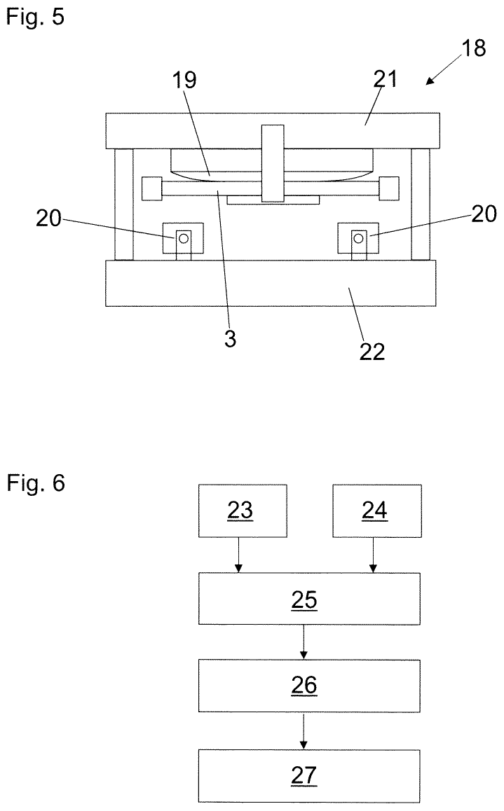

FIG. 5 shows a bending device; and

FIG. 6 illustrates a method for producing a cooler.

### DETAILED DESCRIPTION OF THE INVENTION

FIG. 1 shows a cooler 1 known from the prior art. The cooler 1 comprises a cooler core 28, two coolant reservoirs 4, in particular a first coolant reservoir 41 and a second coolant reservoir 42, and a bracket 5 for fastening the cooler 1 to a motorcycle.

The cooler core 28 has cooling fins 6. The cooling fins 6 are thermally conductively connected to at least one cooling pipe, wherein the at least one cooling pipe is arranged in the interior of the cooler core 28 and is therefore not visible.

Coolant can flow through the at least one cooling pipe from a first coolant reservoir 41 into a second coolant reservoir 42, wherein, on the way, the coolant is cooled by virtue of heat being exchanged with the ambient air.

Here, the first coolant reservoir 41 has a coolant inlet 7, and the second coolant reservoir 42 has a coolant outlet 8. Cooling lines that are attached to the coolant inlet 7 and to the coolant outlet 8 conduct the coolant from the cooler 1 to a component of the motorcycle that is to be cooled, for example to the engine or to a heat exchanger for cooling oil, for example engine oil. Furthermore, the heated coolant is conducted through cooling lines back to the cooler 2 again and is cooled there in the cooler core 28.

One of the two coolant reservoirs 4 has a filling opening 9 with a cover through which coolant can be introduced into the cooler 1 and replenished.

The cooler core 28 is formed as a substantially rectangular bent plate. The cooler core 28 has a bend 10, wherein the bend extends over a major part of the cooler core 28, in particular also through the center of the cooler core 28.

The cooler core 28 has a longitudinal direction and a width direction, wherein the cooler core 28 is bent in the longitudinal direction and is not bent in the width direction.

The bracket 5 is fastened to a side strip 11 on a front side of the cooler core 28. The side strip 11 is arranged in the region of the bend 10, such that the side strip 11 is also bent. The bracket 5 is necessarily adapted to this bend 10.

FIGS. 2a and 2b show a cooler 2 according to the invention. By contrast to the prior art (cooler core 28), the cooler core 3 here has a planar middle region 12, wherein the cooler core 3 has a bend 101, 102 at each of at least two preferably opposite sides of the planar middle region 12. At least two bends, that is a first bend 101 and a second bend 102, are thus provided.

Further properties of the cooler core 3 can correspond to the cooler core 28 from the prior art.

The two bends 101, 102 have the same bend radius and the same bend angle.

In this embodiment, the bend radius is approximately 200 mm, and the bend angle is approximately 20°. However, other dimensions are also conceivable.

The cooler core 3 is not bent along a direction R, which corresponds to a width direction B of the cooler core 3.

The planar middle region 12 is formed substantially rectangular and is arranged in the center of the area of the cooler core 3. It occupies an area of more than one quarter, in particular more than one third, of the total area of the cooler core 3. In absolute numbers, the planar middle region 12 can occupy approximately an area of 200 to 400, in particular of approximately 330, square centimeters. However, other dimensions are also conceivable.

Furthermore, the planar middle region 12 is shorter in the longitudinal direction L of the cooler core 3 than in the width direction B of the cooler core 3. In absolute numbers, the planar middle region 12 can occupy between 140 mm and 150 mm, preferably approximately 145 mm, in the longitudinal direction L of the cooler core 3. This corresponds to more than one quarter, in particular more than one third, of the length of the cooler core 3. However, other dimensions are also conceivable.

The planar middle region 12 extends over the entire width of the cooler core 3. Accordingly, the middle region 12 extends, at both sides, as far as the front side of the cooler core 3, such that the side strips 11 are straight in the adjoining portion 29.

A bracket 30 for fastening the cooler 2 to a motorcycle can be arranged on said straight portions 29 of the side strips 11. Such a bracket is shown in FIG. 2a.

Since it is made possible for the bracket 30 to be arranged in a straight portion 29 of a side strip 11, the bracket 30 can be attached to the side strip 11 even before the cooler core 3 is bent. In particular, the bracket 30 can be brazed on together with the brazing of the cooler core 3 (cooling pipes and cooling fins) and of the side strips 11.

As also in the prior art, at the sides of the bends 101, 102 which are situated opposite the planar middle region 12, there are arranged in each case a planar side region 13, a coolant inlet 7, a coolant outlet 8 and in each case a coolant reservoir 4, 41, 42.

FIG. 3 shows a diagrammatic superimposition of the cooler 1 from the prior art (FIG. 1) and the cooler 2 according to the invention (in particular FIG. 2b). The bracket 5 corresponds here to the bent bracket 5 from FIG. 1. The bend angle in the end region is approximately the same.

It can be seen from FIG. 3 that the planar middle region 12 cuts off the bend 10 of the cooler 1 from the prior art (FIG. 1) on a shorter path. The cooler 2 with the planar middle region 12 thus has a smaller depth than the cooler 1 from the prior art. In the mounted state on the motorcycle, more space is thus created between the front wheel and the engine.

There is thus in particular also more space remaining for a fan 14, which is illustrated in FIG. 4.

FIG. 4 shows a cooler 2 with a planar middle region 12, wherein a fan 14 is also illustrated. The fan 14 is arranged on the planar middle region 12. It is arranged predominantly, in particular over more than three quarters of its area, within the planar middle region 12.

The fan 14 is arranged directly on the cooler core 3, in particular directly on the cooling fins 6. It is fastened directly to the cooler core 3 by means of fastening means 15. There is thus no need for complex fastening to the side strips 11, for example.

The fan 14 illustrated in FIG. 4 corresponds to a typical standard design of a fan. Since it is mounted in the planar middle region 12, it is also possible in particular for the fan 14 to have a standard housing 17. The fan 14 nevertheless lies flat on the cooler core 3.

Owing to the planar middle region 12, a larger fan 14 can thus be chosen than with cooler cores 28 with a continuous bend. As a result, the coolant can be cooled more efficiently.

The fan 14 has a rotatable fan blade that can have a length of approximately 195 mm. This does not protrude overly far beyond the planar middle region 12. The rotatable fan blade is concealed in FIG. 4 by the housing 17.

The fan 14 is preferably electrically operated and, for this purpose, has an electrical connector 16.

FIG. 5 shows a bending device 18 for bending a cooler 2, in particular for producing the cooler core 3. The bending device 18 has a mold 19 that is attached to a movable plate 21. The unbent cooler core can be clamped, in a middle region, to the mold 19. The convex mold 19 has a planar middle region and two curvatures at two opposite sides of the planar middle region.

Two rotatably mounted counterparts 20 are arranged on a fixed table 22. The two counterparts 20 are arranged spaced apart from one another such that they are arranged substantially under the lateral edge regions of the unbent cooler core.

For the bending, the movable plate 21 together with the mold 19 and the cooler core 3 clamped thereon is now pressed downward against the two counterparts 20, such that the cooler core 3 is bent. During the pressing, the counterparts 20 are rotated such that, at the end of the bending operation, said counterparts are inclined in the same way as the planar side regions 13 of the cooler core 3 and lie against the planar side regions 13.

During the bending process, the cooler core 3 (optionally together with the side strips 11) has preferably already been brazed. Furthermore, a bracket 30 can already have been fastened to, in particular brazed onto, the region that is not to be bent.

FIG. 6 shows a block diagram of a method for producing a cooler 2.

A substantially plate-like planar cooler core 3 is provided in a method step 23. At this stage, the cooling fins 6 and the at least one cooling pipe have not yet been fixedly connected to one another.

In parallel with this, a bracket for fastening the cooler 2 to a motorcycle is provided (method step 24).

In a further method step 25, the bracket is arranged on the cooler core 3 or on a side strip 11 on a front side of the cooler core 3. The bracket 30 is particularly preferably arranged in a central region of the cooler core 3 or of the side strip 11. A brazing solder is furthermore applied to the connecting points.

In a further method step 26, the cooler core 3 and the bracket 30 and optionally the side strips 11 are brazed, preferably in a furnace. It is thus possible for the cooler core 3 itself (cooling fins 6 and cooling pipe), side strips 11 and the bracket 30 to be brazed in one step.

In a final method step 27, the cooler core 3 is bent in at least two places, preferably by means of the bending device 18 from FIG. 5, such that the cooler core 3 has a bend 101, 102 at each of at least two preferably opposite sides of a planar middle region 12.

The bracket 30 is arranged so as to remain on a straight portion 29 of the cooler core 3 or of the side strip 11. As a result, the bracket 30 is not affected by the bending. In particular, the bracket 30 is not concomitantly bent, which would also not be possible, or would be possible only with great difficulty, from a production aspect.

### LIST OF REFERENCE NUMBERS

1 Cooler (prior art)
2 Cooler
3 Cooler core
4 Coolant reservoir
41 First coolant reservoir
42 Second coolant reservoir
5 Bracket (prior art)
6 Cooling fins
7 Coolant inlet
8 Coolant outlet
9 Filling opening
10 Bend
101 First bend
102 Second bend
11 Side strip
12 Planar middle region
13 Planar side region
14 Fan
15 Fastening means
16 Electrical connector
17 Housing
18 Bending device
19 Mold
20 Counterpart
21 Movable plate
22 Table
23 Providing a planar cooler core
24 Providing a bracket
25 Arranging
26 Brazing
27 Bending
28 Cooler core (prior art)
29 Straight portion of a side strip
30 Bracket
B Width direction
L Longitudinal direction
R Direction without bend

1. A cooler for cooling liquid, in particular of an engine of a motorcycle, wherein the cooler has a plate-like cooler core for exchanging heat between a coolant and ambient air, wherein the cooler core has a planar middle region, wherein the cooler core has a bend at each of at least two preferably opposite sides of the planar middle region.

2. The cooler according to claim 1, wherein the cooler core is bent in the same direction at least at two opposite sides of the planar middle region, preferably wherein the entire cooler core is formed concave as seen from a first side and convex as seen from a second side.

3. The cooler according to claim 1, wherein the cooler core is not bent along a direction, preferably wherein said direction corresponds to a width direction of the cooler core.

4. The cooler according to claim 1, wherein the planar middle region
is formed substantially rectangular, and/or
is arranged in the center of the area of the cooler core, and/or occupies an area of more than one quarter, in particular more than one third, of the total area of the cooler core, and/or
occupies an area of 200 to 400, in particular of approximately 330, square centimeters.

5. The cooler according to claim 1, wherein the cooler core is formed substantially as a bent rectangular plate, wherein the cooler core has a longitudinal direction and a width direction, wherein the cooler core is longer in the longitudinal direction than in the width direction, and the longitudinal direction is orthogonal to the width direction.

6. The cooler according to claim 5, wherein the planar middle region
is shorter in the longitudinal direction of the cooler core than in the width direction of the cooler core, and/or
is between 140 mm and 150 mm, preferably approximately 145 mm, in size in the longitudinal direction of the cooler core, and/or
occupies more than one quarter, in particular more than one third, of the length of the cooler core in the longitudinal direction of the cooler core, and/or
extends over the entire width of the cooler core.

7. The cooler according to claim 1, wherein the at least two bends that partially delimit the planar middle region
have the same bend radius and/or the same bend angle, and/or
the bend radius of at least one bend is between 180 mm and 220 mm, in particular is approximately 200 mm, and/or
the bend angle of at least one bend is between 18° and 22°, in particular is approximately 20°.

8. The cooler according to claim 1, wherein at least one fan is arranged on the planar middle region, preferably wherein the fan is arranged over the major part of its area, particularly preferably over more than three quarters of its area, within the planar middle region.

9. The cooler according to claim 8, wherein the fan is arranged directly on the cooler core, preferably without an intermediate space, particularly preferably wherein the fan is fastened directly to the cooler core by means of fastening means.

10. The cooler according to claim 1, wherein at least one bracket for fastening the cooler core to a motorcycle is arranged on the cooler core or on at least one side strip on at least one front side of the cooler core, particularly preferably wherein the at least one bracket is fastened to the cooler core or to the at least one side strip by brazing.

11. The cooler according to claim 10, wherein the planar middle region extends as far as at least one front side of the cooler core, wherein the at least one side strip of the at least one front side is formed straight in a portion adjoining the planar middle region, and wherein the at least one bracket is arranged on said straight portion of the at least one side strip.

12. The cooler according to claim 1, wherein:
the cooler core, and/or
at least one bracket for fastening the cooler core to a motorcycle, and/or
at least one side strip on a front side of the cooler core are manufactured from aluminum.

13. The cooler according to claim 1, wherein, at a side of at least one, preferably both, bend(s) that is situated opposite the planar middle region, there is arranged:
a planar side region of the cooler core, and/or
a coolant inlet and/or a coolant outlet, and/or
a coolant reservoir.

14. A motorcycle having the cooler according to claim 1, wherein the cooler core is arranged between the front wheel and the engine of the motorcycle.

15. The motorcycle according to claim 14, wherein the cooler core is bent, at least at two opposite sides of the planar middle region, in the direction of the front wheel.

16. The motorcycle according to claim 14, wherein the fan is arranged between the cooler core and the engine.

17. The motorcycle according to claim 14, wherein coolant lines lead from the cooler:
to the engine, and/or
to a heat exchanger for cooling oil, for example engine oil for the engine.

18. A method for producing the cooler according to claim 1, the method having the following method steps:
providing a substantially plate-like, planar, preferably rectangular, cooler core,
bending the cooler core in at least two places such that the cooler core has a bend at each of at least two preferably opposite sides of a planar middle region.

19. The method according to claim 18, having the following method steps:
arranging at least one fan on the planar middle region, wherein the fan is arranged directly on the cooler core, preferably without an intermediate space,
fastening the at least one fan directly to the cooler core by means of fastening means.

20. The method according to claim 18, wherein the cooler core is brazed before the bending, preferably wherein, before the brazing, at least one bracket is arranged on the cooler core or on at least one side strip on at least one front side of the cooler core, and wherein, during the brazing of the cooler core, the at least one bracket is concomitantly brazed onto the cooler core or onto the at least one side strip.
